(19) United States
(12) Patent Application Publication
(10) Pub. No.: US 2017/0094150 A1
(43) Pub. Date: Mar. 30, 2017

(54) IMAGE CAPTURE SYSTEM AND FOCUSING METHOD THEREOF

(71) Applicant: ABILITY ENTERPRISE CO., LTD., New Taipei City (TW)

(72) Inventors: Jieh-Yi Chang, New Taipei City (TW); Hikaru Masui, New Taipei City (TW)

(21) Appl. No.: 15/260,410

(22) Filed: Sep. 9, 2016

(30) Foreign Application Priority Data
Sep. 25, 2015 (TW) 104131760

(51) Int. Cl. H04N 5/232; G02B 26/08; G02B 7/36; H04N 5/247

(52) U.S. Cl. CPC H04N 5/23212; H04N 5/247; G02B 26/0816; G02B 7/36

(57) ABSTRACT

An image capture system includes a first image capture unit, a second image capture unit and a controller. The first image capture unit includes a first field of view. The second image capture unit includes a second field of view. A difference between the first field of view and the second field of view is larger than zero or less than zero. The controller determines a second focal position of the second image capture unit in accordance with a first focal position of the first image capture unit.

This application claims the benefit of Taiwan application Serial No. 104131760, filed Sep. 25, 2015, the subject matter of which is incorporated herein by reference.

### BACKGROUND OF THE INVENTION

Field of the Invention

The invention relates in general to an image capture system and a focusing method thereof, and more particularly to an image capture system having a plurality of image capture units and allowing the image capture units to complete the focusing procedure within a relatively short time and a focusing method thereof.

Description of the Related Art

In recent years, the image capture system is widely used in various electronic products, such as mobile communication devices, tablet computers, notebooks and surveillance systems. However, with the requirements of thinning and microminiaturization for the electronic products, not only the size and specifications of the image capture system are restricted, but also the lenses for some electronic products cannot be interchanged freely by users in order to capture images in multiple field-of-view modes. Moreover, even though allowed to interchange the lenses of the image capture system for the electronic products, the users still need to re-focus for shooting after interchanging the lenses. Such behavior not only takes time, but also diminishes user experiences.

Therefore, it is desired to provide an image capture technique allowing the users to switch to different field-of-view modes for shooting and focus within a relatively short time.

### SUMMARY OF THE INVENTION

The invention is directed to an image capture system and a focusing method thereof allowing users to switch to different field-of-view modes for shooting and focus within a relatively short time.

According to one aspect of the present invention, an image capture system is provided. The image capture system includes a first image capture unit, a second image capture unit and a controller. The first image capture unit includes a first field of view. The second image capture unit includes a second field of view. A difference between the first field of view and the second field of view is larger than zero or less than zero. The controller determines a second focal position of the second image capture unit in accordance with a first focal position of the first image capture unit.

According to one further aspect of the present invention, an operating method of an image capture system is provided. The image capture system includes a first image capture unit, a second image capture unit and a controller. The first image capture unit includes a first field of view. The second image capture unit includes a second field of view. The operating method includes the following steps. Use the first image capture unit to perform a focusing procedure. During the focusing procedure or after the focusing procedure of the first image capture unit is completed, the controller determines a second focal position of a second lens in accordance with a first focal position of the first image capture unit, wherein a difference between the first field of view and the second field of view is larger than zero or less than zero.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of an image capture system according to one embodiment of the present invention.

FIG. 2 illustrates exemplary images captured respectively by a first image capture unit and a second image capture unit.

FIG. 3 is a schematic diagram of an image capture system according to one embodiment of the present invention.

FIGS. 4A and 4B are schematic diagrams showing that an image capture system according to one embodiment of the present invention captures images respectively with the first image capture unit and the second image capture unit.

FIG. 5 is a schematic diagram of an image capture system according to one embodiment of the present invention.

FIG. 6 is a schematic diagram of a plurality of image frames captured by the first image capture unit and the second image capture unit of the image capture systems.

### DETAILED DESCRIPTION OF THE INVENTION

Below, exemplary embodiments will be described in detail with reference to accompanying drawings. In addition to these detailed descriptions, the inventive concept may be widely implemented in other embodiments. Any alternatives, modifications and equivalent variations of the embodiments are included within the scope of the present invention which should be according to the appended claims hereinafter. In the following detailed description, for purposes of explanation, numerous specific details are set forth in order to provide a thorough understanding of the disclosed embodiments. It will be apparent, however, that one or more embodiments may be practiced without some or all of these specific details. In other instances, well-known steps and elements are not described in detail in order to avoid unnecessary restricts. The same or like elements are designated by the same or like reference numerals in the drawings. It should be particularly noticed that the drawings are to be regard as an illustrative sense. The illustrations may not be necessarily drawn to scale or refer to the actual amount, unless there is an additional description.

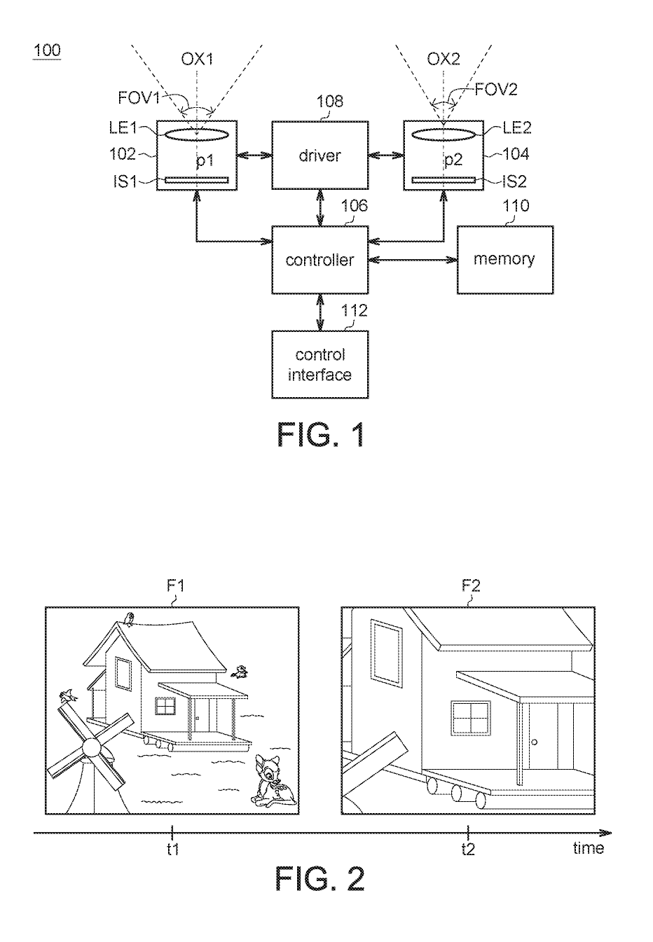

FIG. 1 is a schematic diagram of an image capture system 100 according to one embodiment of the present invention. The image capture system 100 may be as handheld communication systems, automotive camera systems, surveillance systems, digital cameras or digital video cameras, or any electronic systems capable of capturing image.

The image capture system 100 mainly comprises a first image capture unit 102, a second image capture unit 104, a controller 106, a driver 108 and a memory 110. The first image capture unit 102 comprises a first lens LE1 with a first field of view FOV1 and a first optical axis OX1. The second image capture unit 104 comprises a second lens LE2 with a second field of view FOV2 and a second optical axis OX2. The first lens LE1 and the second lens LE2 may respectively comprise one or more than one lens and/or one or more than one focusing lens group, and the focusing lens group may comprise one or more than one focusing lens. Moreover, the first lens LE1 and the second lens LE2 respectively have an equivalent focal length. The first optical axis OX1 and the second optical axis OX2 may be substantially parallel or intersected with an angle. The memory 110 may be built in the image capture system 100 or may comprise a removable memory card.

In one embodiment, the first field of view FOV1 and the second field of view FOV2 may be unequal. In other words, a difference between the first field of view FOV1 and the second field of view FOV2 is larger than zero or less than zero. In other words, the difference is an absolute value which comes from an angle of the second field of view FOV2 subtracted from an angle of the first field of view FOV1. That is, |(first field of view FOV1)−(second field of view FOV2)|>0.

In another embodiment, the first field of view FOV1 and the second field of view FOV2 have the angle values respectively selected from any two of the wide-angle range, standard range and telephoto range. In other words, the first field of view FOV1 may be u degrees, and the second field of view FOV2 may be v degrees. If u is a viewing angle within the standard range, v may be a viewing angle within the wide-angle range or the telephoto range, but the present invention is not limited thereto. If u is a viewing angle within the wide-angle range or the telephoto range, v may be a viewing angle within the standard range or the telephoto range, or may be a viewing angle within the standard range or the wide-angle range. Moreover, the wide-angle range may be from 60° to 90°, the standard range may be from 40° to 50°, and/or the telephoto range may be from 2° to 30°. However, the present invention is not limited thereto; u and/or v may also be any other unequal values.

In this embodiment, the first image capture unit 102 further comprises a first image sensor IS1 disposed at an imaging plane of the first lens LE1. The second image capture unit 104 further comprises a second image sensor IS2 disposed at an imaging plane of the second lens LE2. The first image sensor IS1 and/or the second image sensor IS2 may be a charge coupled device (CCD), a complementary metal-oxide semiconductor (CMOS) or any photoelectric element. In another embodiment, the first image sensor IS1 and the second image sensor IS2 may be different types in accordance with the first field of view FOV1 and the second field of view FOV2. For example, the range of the ratio of size of the first image sensor IS1 to the second image sensor IS2 may be between 100% and 50%, and the definition of the ratio of size includes but does not limit to the ratio of total area or the ratio of diagonal length of the first image sensor IS1 and the second image sensor IS2.

In one embodiment, after the focusing procedure of any one of the image capture units, the controller 106 may determine the location of the focusing lens group of another image capture unit(s) in accordance with the focal position of the focused image capture unit. For example, if the first image capture unit 102 completed the focusing procedure, the focusing lens group of the first lens LE1 may be locate at a first focal position p1. The controller 106 may determine a second focal position p2 of the focusing lens group of the second lens LE2 in accordance with a mapping function and the first focal position p1. The first focal position p1 and/or the second focal position p2 may be local parameters set of each focusing lens. The mapping function may include but not limit to at least one Mathematical set, at least one comparing table, at least one equation or at least one operation, or the mapping function may include at least two of the Mathematical set, the comparing table, the equation and the operation.

As shown in FIG. 1, the mapping function may be stored in the controller 106 or the memory 110. Specifically, the mapping function may record the corresponding local relation at different focal positions where each of the focusing lens groups of the first lens LE1 and the second lens LE2 is respectively locates. In other words, when the first focal position p1 of the first lens LE1 is confirmed, the controller 106 may determine the second focal position p2 of the second lens LE2 in accordance with the mapping function. On the contrary, if the second focal position p2 of the second lens LE2 is confirmed, the controller 106 may also determine the first focal position p1 of the first lens LE1 in accordance with the mapping function.

For example, if the mapping function is a comparing table, the corresponding local relation at the first focal position p1 of the first lens LE1 and the second focal position p2 of the second lens LE2 is shown as the following Table 1.

TABLE 1

| Object distance (m) | First focal position p1 | Second focal position p2 |
|---|---|---|
| s1 | x1 | y1 |
| s2 | x2 | y2 |
| s3 | x3 | y3 |
| s4 | x4 | y4 |

As shown in Table 1, if a s2-meter-distant object shall be captured with the first focal position p2 at x2, the second focal position p2 may be looked up in Table 1 by the controller 106 at y2.

In one embodiment, the mapping function may comprise parameters such as object distance, focal length, image distance, Gaussian imaging formula and/or trigonometric function.

Moreover, in the mapping function, the relation of the first focal position p1 and the second focal position p2 may be one-to-one, one-to-many, many-to-one or many-to-many. In other words, one first focal position p1 may map to one or more second focal positions p2; one or more first focal positions p1 may map to one second focal position p2; or plural first focal positions p1 may map to plural second focal positions p2.

In one embodiment, the controller 106 may have a further confirmation while obtaining several focal positions from a one-to-many mapping function or a many-to-many mapping function, so as to ensure a better focal position. For example, the controller 106 further performs a focusing procedure in shorter range with the several focal positions for obtaining a better focal position.

In another embodiment, the controller 106 and/or the memory 110 may further store other parameters of the first lens LE1 and/or the second lens LE2 including, but not limiting to, equivalent focal length, relative object distance, image distance, viewing angle, etc. In addition, the controller 106 may also determine the first focal position p1 and/or the second focal position p2 in accordance with the above parameters.

Furthermore, the driver 108 may drive the focusing lens groups of the first lens LE1 and the second lens LE2 respectively to the first focal position p1 and the second focal position p2 in accordance with the control signal from the controller 106. The driver 108 may be an actuator.

Moreover, the image capture system 100 may further comprise a control interface 112. The control interface 112 may be a mechanically control interface or an electronically control interface, or a control interface combined with peripheral device. The control interface 112 may include, but not limit to, a touch interface, a button interface, a remote control interface and a wired or wireless interface.

In one embodiment, when the first lens LE1 has performed the focusing procedure, then the controller 106 asks the driver 108 to drive the focusing lens group of the second lens LE2 to the second focal position p2 in accordance with the mapping function and the finally first focal position p1. In another embodiment, while the first lens LE1 performs the focusing procedure, the controller 106 simultaneously asks the driver 108 to drive the focusing lens group of the second lens LE2 to the temporary second focal position p2 in accordance with the mapping function and the temporary first focal position p1 immediately. On the contrary, if the second lens LE2 performs the focusing procedure, the controller 106 may also let the focusing lens group of the first lens LE1 be driven to the finally/temporary first focal position p1 in accordance with the mapping function and the finally/temporary second focal position p2.

In another embodiment, under the premise of shooting by the first image capture unit 102, if a user or the image capture system 100 shall switch to the second image capture unit 104 for shooting, the controller 106 asks the driver 108 to drive the focusing lens group of the second lens LE2 to the second focal position p2 in accordance with the mapping function and the current first focal position p1. Conversely, it may also switch to the first image capture unit 102 from the second image capture unit 104 for shooting, and the driver 108 drives the first lens LE1 to the first focal position p1 in accordance with the mapping function and the current second focal position p2.

In other words, during the focusing procedure and/or the shooting process, the controller 106 may let the first image capture unit 102/the second image capture unit 104 actuate synchronously in accordance with the second focal position p2/the first focal position p1. Alternatively, after the focusing procedure or the shooting process of one image capture unit and/or the switching from one image capture module to the other image capture unit, the other image capture unit may be driven to its focal position.

FIG. 2 illustrates exemplary images captured by the first image capture unit 102 and the second image capture unit 104 respectively. The image capture system 100 captures an image frame F1 at a first time point t1 with the first image capture unit 102 and captures an image frame F2 at a second time point t2 with the second image capture unit 104. Because the first field of view FOV1 is not equal to the second field of view FOV2, the first image capture unit 102 and the second image capture unit 104 may capture the image frames F1 and F2 respectively with different fields of view.

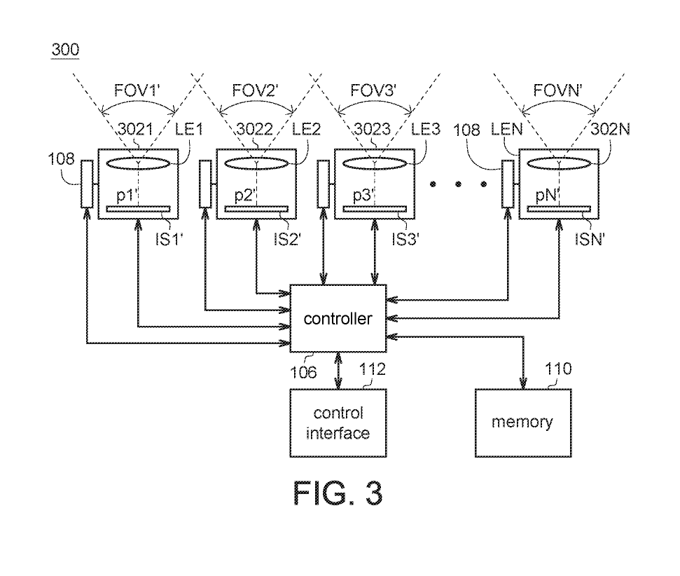

FIG. 3 is a schematic diagram of an image capture system 300 according to one embodiment of the present invention. The main difference between the image capture system 300 and the image capture system 100 is: the image capture system 300 comprises N image capture modules 3021-302N, wherein N is a positive integer and N≧2. The image capture units 3021-302N have fields of view FOV1′-FOVN′ respectively, wherein angles of the fields of view FOV1′-FOVN′ are unequal mutually; the image capture units 3021-302N comprise lenses LE1′-LEN′ and image sensors IS1′-ISN′ respectively.

After focusing procedure with one of the lenses LE1′-LEN′, the controller 106 may determine the focal positions of the other lenses in accordance with the focal position of the focused lens and the mapping function. Afterwards, the driver 108 may drive at least one focusing lens group of the other lenses to its focal position. In one embodiment, the controller 106 may also let the driver 108 drive the focusing lens group of the designated lens to its focal position in accordance with a signal from a control interface 112.

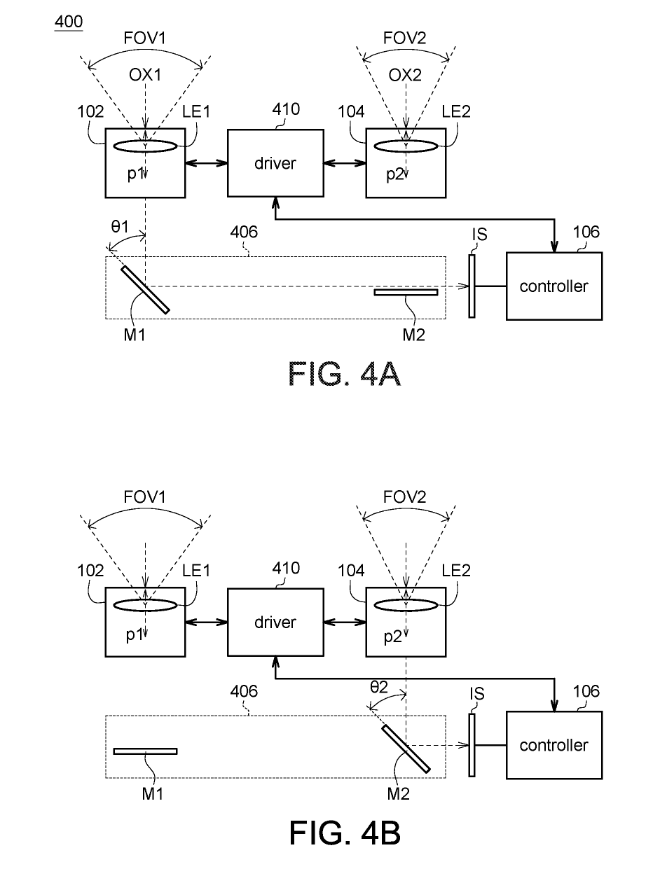

FIGS. 4A and 4B are schematic diagrams showing that an image capture system 400 according to one embodiment of the present invention captures images respectively with the first image capture unit 102 and the second image capture unit 104. As shown in FIGS. 4A and 4B, the image capture system 400 mainly comprises a first image capture unit 102, a second image capture unit 104, an image sensor IS, an optical switch 406, a controller 106 and a driver 410. The first field of view FOV1 of the first image capture unit 102 and the second field of view FOV2 of the second image capture unit 104 are unequal. In other words, the first field of view FOV1 may be larger than or less than the second field of view FOV2, and the difference between the first field of view FOV1 and the second field of view FOV2 is larger than zero or less than zero.

In contrast with FIGS. 1, 4A and 4B, the main difference between the image capture system 400 and the image capture system 100 is: the first image capture unit 102 and the second image capture unit 104 of the image capture system 400 may share the image sensor IS. The image sensor IS, the first lens LE1 and the second lens LE2 may not on one straight line, and the image capture system 400 may adopt the optical switch 406 for the first image capture unit 102 and the second image capture unit 104 to share the image sensor IS. In one embodiment, a normal line of the imaging plane of the image sensor IS may be substantially perpendicular to the first optical axis OX1 and/or the second optical axis OX2 respectively, but the present invention is not limited thereto. In another embodiment, the normal line may not necessarily be substantially perpendicular to the first optical axis OX1 and/or the second optical axis OX2.

Moreover, the driver 410 may drive the optical switch 406 in accordance with the controller 106 or the command from the control interface (not shown), and the light beam that passed through the first lens LE1 or the second lens LE2 is imaged on the image sensor IS. Specifically, the optical switch 406 mainly comprises a first reflector M1 and a second reflector M2. At least one direction of the reflecting surface of the first reflector M1 and the second reflector M2 may be changed by the driver 410. The first reflector M1 and the second reflector M2 may be a prism or a plane mirror respectively, but the present invention in not limited thereto.

As shown in FIG. 4A, an angle θ1 is between the first optical axis OX1 and the reflecting surface of the first reflector M1. A part of the light beams may travel towards the image sensor IS after passing through the first lens LE1; meanwhile, a part of the light beam that passed through the second lens LE2 may not travel towards the image sensor IS. Concretely, the second reflector M2 may be rotated to another direction where the light beam that passed through the second lens LE2 shall not travel to the image sensor IS. For example, the reflecting surface of the second reflector M2 may substantially perpendicular to the second optical axis OX2, but the present invention is not limited thereto.

Then refer to FIG. 4B. Similarly, the driver 410 may be asked to drive the first reflector M1 and the second reflector M2 to rotate, and an angle θ2 may exist between the second optical axis OX2 and the second reflector M2 (wherein, the angle θ2#0° and θ2#180°). Therefore, the light beam that passed through the second lens LE2 may travel to the image sensor IS, and the first optical axis OX1 and the reflecting surface of the first reflector M1 may detach from the specific angle θ1 (i.e., the original value of the angle θ1′ may be changed). In one embodiment, the reflecting surface of the first reflector M1 and the first optical axis OX1 may be substantially perpendicular and the angle θ1 and the angle θ2 may be equal or unequal.

After the focusing procedure with the first image capture unit 102 (or the second image capture unit 104), the controller 106 may compute and/or determine the second focal position p2 (or the first focal position p1) in accordance with the first focal position p1 (or the second focal position p2) and the mapping function.

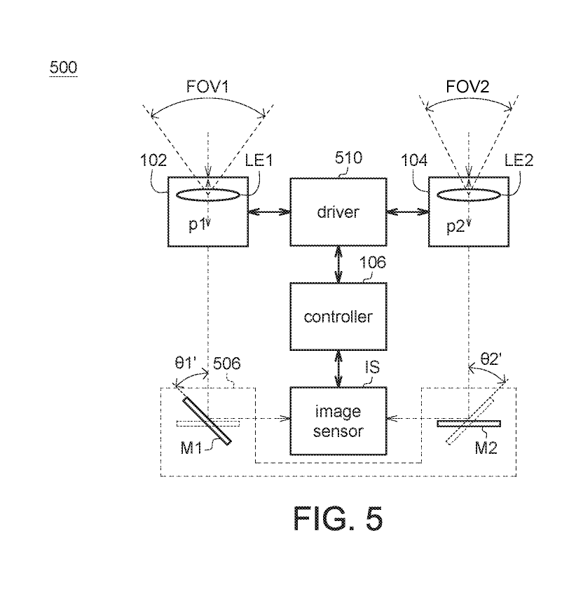

FIG. 5 is a schematic diagram of an image capture system 500 according to one embodiment of the present invention. In contrast with FIGS. 4A and 5, the main difference between the image capture system 500 and the image capture system 400 is: the layout of the optical switches 506 and 406 of the image capture systems 500 and 400. The optical switch 506 may guide the light beam that passed through the first image capture unit 102 and/or the second image capture unit 104 to travel to the image sensor IS.

As shown in FIG. 5, the image capture system 500 mainly comprises a first image capture unit 102, a second image capture unit 104, an image sensor IS, an optical switch 506, a controller 106 and a driver 510. The first image capture unit 102 comprises a first lens LE1, the second image capture unit 104 comprises a second lens LE2, and the first field of view FOV1 is not equal to the second field of view FOV2. In other words, the first field of view FOV1 may be larger than or less than the second field of view FOV2, and the difference between the first field of view FOV1 and the second field of view FOV2 is larger than zero or less than zero.

Referring to FIG. 5, for the light beam that passed through the first lens LE1 to travel to the image sensor IS, an angle θ1′ may exist between the reflecting surface of the first reflector M1 and the first optical axis OX1, and the light beam that passed through the second lens LE2 may not travel to the image sensor IS. In one embodiment, the reflecting surface of the second reflector M2 and the second optical axis OX2 may be substantially perpendicular, but the present invention is not limited thereto.

In another embodiment, if the image sensor IS shall receive the light beam that passed through the second lens LE2, the locations and/or the angles of the first reflector M1 and/or the second reflector M2 may get to be changed respectively. Further, an angle θ2′ may exist between the reflecting surface of the second reflector M2 and the second optical axis OX2, and the angle θ1′ between the reflecting surface of the first reflector M1 and the first optical axis OX1 may be detach from the specific angle of θ1′ (i.e., the original value of the angle θ1′ may be changed).

After the focusing procedure with the first image capture unit 102 or the second image capture unit 104, the controller 106 may determine the second focal position p2 or the first focal position p1 in accordance with the focused first focal position p1 or the focused second focal position p2, and the driver 510 drives the focusing lens group. Wherein the driver may be driven by a command from the controller 106.

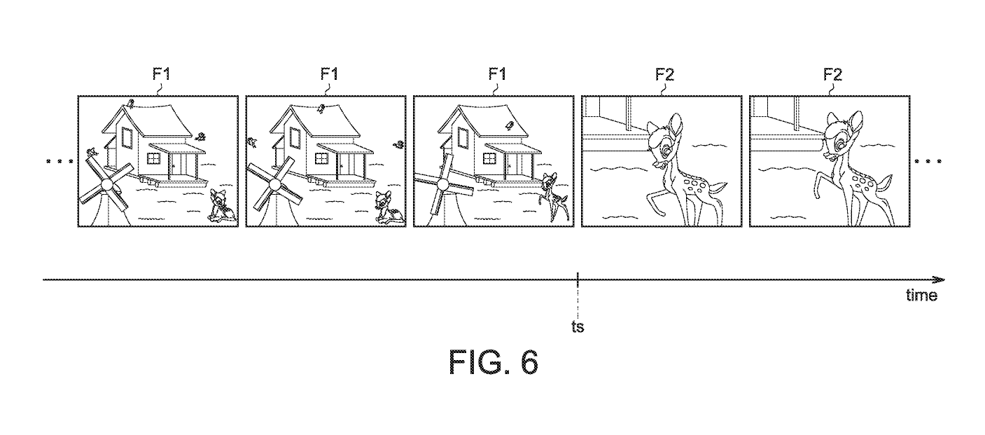

FIG. 6 is a schematic diagram of the image capture systems 100, 300, 400 and 500 using the first image capture unit 102 to capture at least one image frame F1 and using the second image capture unit 104 to capture at least one image frame F2.

As shown in FIG. 6, before a specific time point ts, the image capture systems 100, 300, 400 and 500 use the first image capture unit 102 to capture the image frame F1 with the first focal position p1. While the image frame F1 is captured by the first image capture unit 102, or during a time interval after the first focal position p1 is confirmed and before the image frames F1 is captured, the controller 106 may determine the second focal position p2 in accordance with the first focal position p1 and the mapping function. Moreover, the drivers 108, 410 and 510 may be actuated after the second focal position p2 is confirmed.

After the specific time point ts, the second image capture unit 104 replaces the first image capture unit 102 to capture, and the second image capture unit 104 captures the image frame F2 at the second focal position p2. In this imaging period, the second lens LE2 has been located at the second focal position p2.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image capture system, comprising:
a first image capture unit comprising a first field of view;
a second image capture unit comprising a second field of view, a difference between the first field of view and the second field of view being larger than zero or less than zero; and
a controller determining a second focal position of the second image capture unit in accordance with a first focal position of the first image capture unit.

2. The image capture system according to claim 1, further comprising a first image sensor and a second image sensor, a light beam incident in the first image capture unit being imaged by the first image sensor, and a light beam incident in the second image capture unit being imaged by the second image sensor.

3. The image capture system according to claim 1, further comprising an image sensor, a light beam that passed through the first image capture unit being imaged by the image sensor, and/or a light beam that passed through the second image capture unit being imaged by the image sensor.

4. The image capture system according to claim 3, further comprising an optical switch, the light beam that passed through the first image capture unit or the second image capture unit traveling to the image sensor with the optical switch.

5. The image capture system according to claim 4, further comprising a driver, the driver driving the optical switch to guide the light beam that passed through the first image capture unit or the second image capture unit to the image sensor.

6. The image capture system according to claim 4, wherein the optical switch comprises a first reflector and a second reflector, the light beam that passed through the first image capture unit travels to the image sensor with the first reflector, and the light beam that passed through the second image capture unit travels to the image sensor with the second reflector.

7. The image capture system according to claim 1, further comprising a mapping function, the controller determining the second focal position in accordance with the mapping function and the first focal position.

8. The image capture system according to claim 7, wherein the mapping function comprises a Mathematical set, a comparing table, an equation or an operation, or the mapping function comprises at least two of the Mathematical set, the comparing table, the equation and the operation.

9. The image capture system according to claim 7, further comprising a memory, the mapping function being stored in the controller or the memory.

10. An image capture system having a mapping function, the image capture system comprising:
a first image capture unit comprising a first lens;
a second image capture unit comprising a second lens; and
a controller determining a second focal position of the second lens in accordance with a first focal position of the first lens and the mapping function.

11. The image capture system according to claim 10, wherein a first field of view of the first image capture unit and a second field of view of the second image capture unit are unequal.

12. The image capture system according to claim 10, further comprising one or more than one image sensor, a light beam that passed through the first lens and/or the second lens being imaged by the image sensor.

13. The image capture system according to claim 12, further comprising an optical switch, the light beam that passed through the first lens or the second lens traveling to the image sensor with the optical switch.

14. The image capture system according to claim 13, further comprising a driver, the driver driving the optical switch to guide the light beam that passed through the first lens and/or the second lens to the image sensor.

15. The image capture system according to claim 14, wherein the optical switch comprises one or more than one reflector, and the light beam that passed through the first image capture unit and/or the second image capture unit travels to the image sensor with the reflector.

16. The image capture system according to claim 10, wherein the mapping function comprises a Mathematical set, a comparing table, an equation or an operation, or the mapping function comprises at least two of the Mathematical set, the comparing table, the equation and the operation.

17. The image capture system according to claim 10, further comprising a memory, the mapping function being stored in the memory.

18. A focusing method for an image capture system, the image capture system comprising a first image capture unit having a first lens, a second image capture unit having a second lens, and a mapping function, the focusing method comprising:
performing a focusing procedure with the first image capture unit; and
determining a second focal position of the second lens in accordance with the mapping function and a first focal position of the first lens during or after the focusing procedure of the first image capture unit.

19. The focusing method according to claim 18, wherein a first field of view of the first image capture unit and a second field of view of the second image capture unit are unequal.

20. The focusing method according to claim 18, further comprising determining the second focal position by a controller in accordance with at least one of a Mathematical set, a comparing table, an equation and an operation of the mapping function.
